(19) United States
(12) Patent Application Publication
(10) Pub. No.: US 2026/0276158 A1
(43) Pub. Date: Sep. 17, 2026

(54) METHODS, INTERNET OF THINGS SYSTEMS, AND STORAGE MEDIA FOR AUTONOMOUS PROTECTION OF SMART GAS PIPELINES

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN); Lei ZHANG, Chengdu (CN); Zhubin CHENG, Chengdu (CN)

(73) Assignee: CHENGDU QINCHUAN IOT TECHNOLOGY CO., LTD., Chengdu (CN)

(21) Appl. No.: 19/669,935

(22) Filed: May 6, 2026

(30) Foreign Application Priority Data
Feb. 9, 2026 (CN) 202610179431.1

(51) Int. Cl. F17D 3/00; G16Y 10/35; G16Y 40/10; G16Y 40/30

(52) U.S. Cl. CPC F17D 3/00; G16Y 10/35; G16Y 40/10; G16Y 40/30

(57) ABSTRACT

A method, an IoT system and a storage medium for autonomous protection of smart gas pipelines are provided. The method is executed by a government safety supervision management platform. The method includes: obtaining equipment acquisition data and terminal user feature through a gas company management platform; obtaining region feature data based on an integrated database; and determining a protection parameter and sending the protection parameter to an automation controller based on the equipment acquisition data, the region feature data, and the terminal user feature. The system includes a government safety supervision management platform and a government safety supervision object platform. The government safety supervision management platform includes an integrated database. The government safety supervision object platform includes a gas company management platform. The method is run after computer instructions stored on a non-transitory computer-readable storage medium are read.

### CROSS-REFERENCE TO RELATED APPLICATIONS

This application claims priority of Chinese Application No. 202610179431.1, filed on February 9, 2026, the entire contents of which are hereby incorporated by reference.

### TECHNICAL FIELD

The present disclosure relates to the field of gas safety technology, and in particular to a method, an Internet of Things (IoT) system, and a storage medium for autonomous protection of smart gas pipelines.

### BACKGROUND

As an important component of urban infrastructure, gas pipelines undertake a task of gas transportation. Due to the flammable and explosive characteristics of gas, protective facilities are usually installed during the laying of gas pipelines to reduce a risk of pipeline deformation, pipeline displacement, or even pipeline leakage caused by external forces.

Currently, among the means to enhance the protective effect of the protective facilities on the gas pipelines, dynamic protection tailored to different levels of pipeline leakage, as well as remote control and early warning of protection, are not considered, resulting in poor protective effects for the gas pipelines.

Therefore, it is desirable to propose a method, an IoT system, and a storage medium for autonomous protection of smart gas pipelines, which dynamically adjust the operation of protection equipment based on monitoring data and improve the protective effect and emergency response capability of the gas pipelines through automatic triggering of the protection equipment, ensuring the safety and stability of gas transportation.

### SUMMARY

One or more embodiments of the present disclosure provide an IoT system for autonomous protection of smart gas pipelines. The IoT system includes a government safety supervision management platform and a government safety supervision object platform. The government safety supervision management platform includes an integrated database, and the government safety supervision object platform includes a gas company management platform. The government safety supervision management platform is configured to execute a method for autonomous protection of smart gas pipelines.

One or more embodiments of the present disclosure provide a method for autonomous protection of smart gas pipelines. The method is executed by the government safety supervision management platform in the IoT system for autonomous protection of smart gas pipelines. The method includes: obtaining equipment acquisition data and a terminal user feature through the gas company management platform; obtaining region feature data based on the integrated database; and determining a protection parameter and sending the protection parameter to an automation controller based on the equipment acquisition data, the region feature data, and the terminal user feature. The automation controller is configured to control protection equipment to operate based on the protection parameter. The protection parameter includes at least one of a remote control parameter or a local trigger parameter. The automation controller controlling the protection equipment to operate based on the remote control parameter includes: controlling operation of a water mist spraying device, a pressure regulating valve, and a shut-off valve based on a first configuration parameter. The automation controller controlling the protection equipment to operate based on the local trigger parameter includes: determining whether one or more trigger conditions are triggered; and in response to determining that the one or more trigger conditions are triggered, controlling protection equipment corresponding to a triggered trigger condition to operate based on a second configuration parameter of the protection equipment corresponding to the triggered trigger condition.

One or more embodiments of the present disclosure provide a non-transitory computer-readable storage medium. The storage medium stores computer instructions. When the computer instructions are executed by a computer, the method for autonomous protection of smart gas pipelines is implemented.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary platform structure of an IoT system for autonomous protection of smart gas pipelines according to some embodiments of the present disclosure;

FIG. 2 is a flowchart illustrating an exemplary method for autonomous protection of smart gas pipelines according to some embodiments of the present disclosure;

FIG. 3 is an exemplary schematic diagram of determining a protection parameter according to some embodiments of the present disclosure; and

FIG. 4 is a flowchart illustrating an exemplary process of determining a remote control parameter according to some embodiments of the present disclosure.

### DETAILED DESCRIPTION

The accompanying drawings, which are required to be used in the description of the embodiments, are briefly described below. The accompanying drawings do not represent the entirety of the embodiments.

When describing operations performed step-by-step in the embodiments of the present disclosure, unless otherwise specified, the order of the operations may be adjusted, operations may be omitted, and additional steps may be included in the processes.

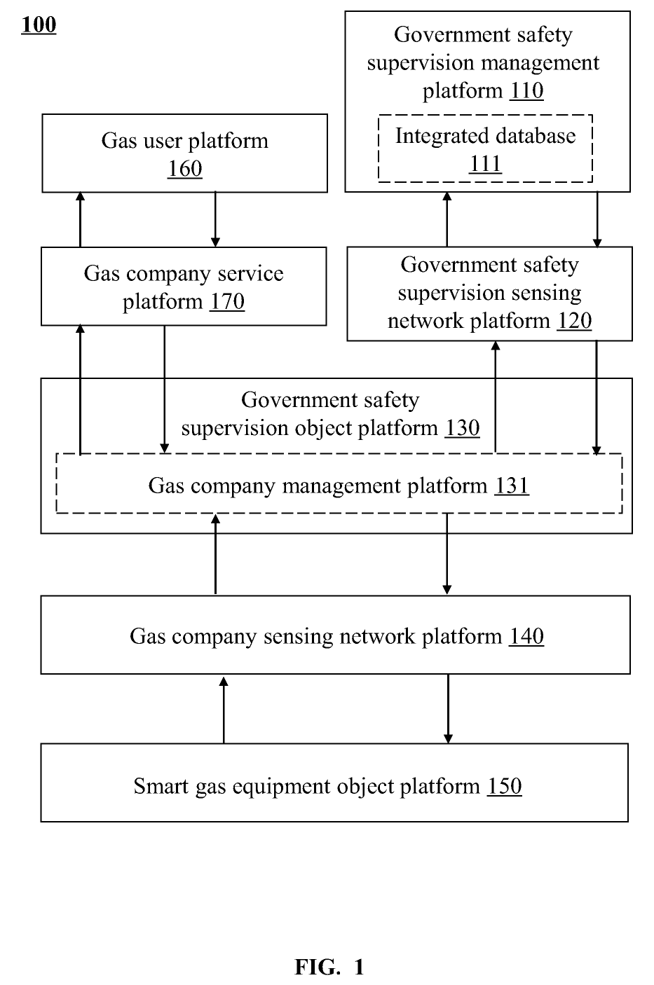

FIG. 1 is a schematic diagram illustrating an exemplary platform structure of an IoT system for autonomous protection of smart gas pipelines according to some embodiments of the present disclosure.

In some embodiments, as shown in FIG. 1, an IoT system 100 for autonomous protection of smart gas pipelines may include a government safety supervision management platform 110, a government safety supervision sensing network platform 120, a government safety supervision object platform 130, a gas company sensing network platform 140, a smart gas equipment object platform 150, a gas user platform 160, and a gas company service platform 170.

The government safety supervision management platform 110 refers to a platform for supervising and managing the safety of gas pipeline networks, which may be configured as a processor or a server.

As shown in FIG. 1, the government safety supervision management platform 110 may include an integrated database 111.

The integrated database refers to a database that aggregates and stores large amounts of data.

In some embodiments, the government safety supervision management platform 110 may be configured to: obtain equipment acquisition data and a terminal user feature through the gas company management platform; obtain region feature data based on the integrated database; and determine a protection parameter and send the protection parameter to an automation controller based on the equipment acquisition data, the region feature data, and the terminal user feature, wherein the automation controller is configured to control protection equipment to operate based on the protection parameter.

In some embodiments, the government safety supervision management platform 110 may be further configured to: determine a startup result of the protection equipment in response to determining that the automation controller controls the protection equipment to start up; generate a recovery instruction and send the recovery instruction to an automatic recovery device of the protection equipment in response to determining that the startup result is a successful startup; and generate a maintenance instruction and send the maintenance instruction to the gas company service platform in response to determining that the startup result is a failed startup.

In some embodiments, the government safety supervision management platform 110 may be further configured to: obtain pipeline structure data based on the integrated database; construct a protection feature map based on the pipeline structure data, the region feature data, the terminal user feature, historical acquisition data, and future weather data; determine an execution condition parameter through a protection adjustment model based on the protection feature map; and determine the protection parameter based on the execution condition parameter.

In some embodiments, the government safety supervision management platform 110 may be further configured to train the protection adjustment model based on a sample data set.

In some embodiments, the government safety supervision management platform 110 may be further configured to: obtain historical activation data of the protection equipment based on the integrated database; determine a device aging index of the protection equipment based on the historical activation data; and determine the remote control parameter based on the device aging index, the equipment acquisition data, the region feature data, and the terminal user feature.

In some embodiments, the government safety supervision management platform 110 may be further configured to send the device aging index to the automation controller. The automation controller is further configured to determine, based on the device aging index, the equipment acquisition data, and the one or more trigger conditions, whether to control the protection equipment corresponding to the triggered trigger condition to operate based on a second configuration parameter of the protection equipment corresponding to the triggered trigger condition.

The government safety supervision sensing network platform 120 refers to a functional platform for managing government sensing communications, which may be configured as a communication network, a gateway, etc.

The government safety supervision object platform 130 refers to an object platform that generates sensing information and executes control information, which may be configured as a processor, a server, etc.

As shown in FIG. 1, the government safety supervision object platform 130 includes a gas company management platform 131.

The gas company management platform 131 may be configured as a processor, a server, etc.

As shown in FIG. 1, the gas company management platform 131 is communicatively connected to the government safety supervision management platform 110 through the government safety supervision sensing network platform 120; communicatively connected to the smart gas equipment object platform 150 through the gas company sensing network platform 140; and communicatively connected to the gas user platform 160 through the gas company service platform 170.

The gas company sensing network platform 140 refers to a comprehensive management platform for sensing information of a gas company, which may be configured as a communication network, a gateway, etc.

The smart gas equipment object platform 150 refers to a functional platform that generates sensing information and executes control information, such as various sensors or operating equipment. In some embodiments, the smart gas equipment object platform 150 may include an automation controller, protection equipment, and a data acquisition device.

The automation controller may be a programmable logic controller (PLC), a micro control unit, etc.

The protection equipment refers to equipment that provides safety protection for a gas pipeline. In some embodiments, the protection equipment may include a water mist spraying device, a pressure regulating valve, and a shut-off valve.

In some embodiments, the data acquisition device may include a gas monitoring device and an environment sensing device.

The gas monitoring device may include a gas temperature sensor, a gas flow rate sensor, a gas pressure sensor, etc., installed inside the gas pipeline. The environment sensing device may include an environment temperature sensor, an environment humidity sensor, etc., installed in an external environment of the gas pipeline.

The gas user platform 160 refers to a platform for interacting with gas users, and the gas company service platform 170 refers to a platform for interacting with gas workers, both of which may be configured as terminals or servers, such as mobile phones, computers, etc.

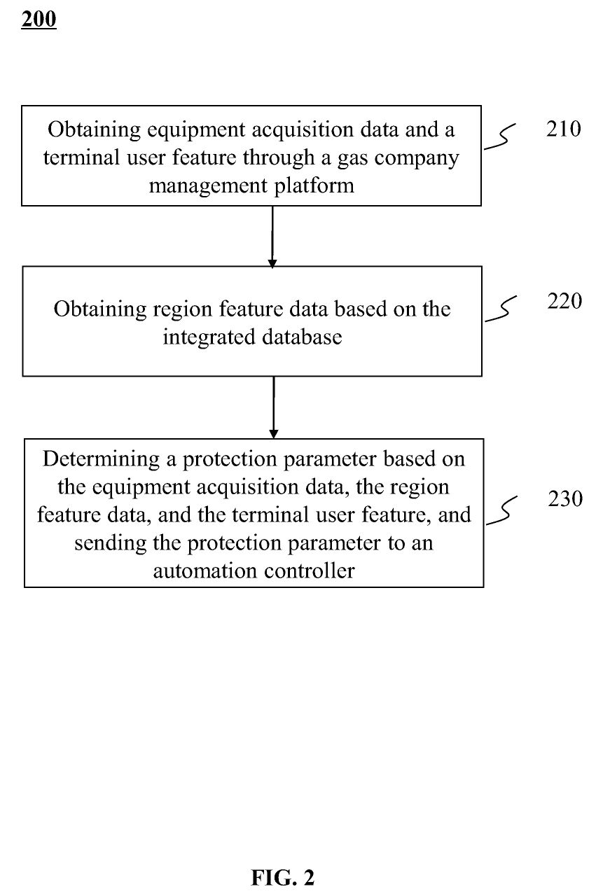

FIG. 2 is a flowchart illustrating an exemplary method for autonomous protection of smart gas pipelines according to some embodiments of the present disclosure. As shown in FIG. 2, a process 200 includes the following steps 210-230. In some embodiments, the process 200 may be executed by the government safety supervision management platform 110.

In 210, equipment acquisition data and a terminal user feature are obtained through a gas company management platform.

In some embodiments, the government safety supervision management platform may obtain the equipment acquisition data collected and uploaded by a data acquisition device from a smart gas equipment object platform, and obtain the terminal user feature from a gas user platform, via a gas company management platform and a gas company sensing network platform.

The equipment acquisition data may include gas monitoring data collected by a gas monitoring device and environment sensing data collected by a environment sensing device. The gas monitoring data may include a gas temperature, a gas pressure, etc. The environment sensing data may include an environment temperature, an environment humidity, etc.

The terminal user feature refers to a feature of a user using gas terminal equipment, such as a historical gas usage record of the user.

In 220, region feature data is obtained based on the integrated database.

The region feature data refers to feature data characterizing an area where a gas pipeline is located, including region population information, region facility information, etc., of the area where the gas pipeline is located.

The region population information may include a population density, etc. The region facility information may include an area type (e.g., an industrial zone, a residential area, etc.), a building density within the area, etc.

In 230, a protection parameter is determined based on the equipment acquisition data, the region feature data, and the terminal user feature, and the protection parameter is sent to an automation controller.

The protection parameter refers to an operating parameter of protection equipment. In some embodiments, the protection parameter includes at least one of a remote control parameter or a local trigger parameter.

In some embodiments, the remote control parameter includes a first configuration parameter of the protection equipment.

The first configuration parameter may include a spray speed, a spray volume, a spray range of a water mist spraying device, a rotation angle of a pressure regulating valve, and a closing amplitude of a shut-off valve.

The rotation angle may include positive and negative values. The positive values represent clockwise pressure increase, the negative values represent counterclockwise pressure decrease, and a magnitude of the rotation angle represents a magnitude of pressure adjustment.

The closing amplitude may be represented by a percentage from 0-100%. A larger value indicates a greater closing amplitude, meaning a smaller channel for gas flow within the gas pipeline.

In some embodiments, the government safety supervision management platform may generate the first configuration parameter of the protection equipment (i.e., the remote control parameter) based on current data and send the first configuration parameter to the automation controller. The automation controller is configured to control the protection equipment to operate based on the first configuration parameter. Related content regarding this part may be found in the description below.

In some embodiments, the local trigger parameter includes one or more trigger conditions and a second configuration parameter of the protection equipment corresponding to a triggered trigger condition when the one or more trigger conditions are triggered.

The one or more trigger conditions refer to one or more conditions for determining whether the protection equipment needs to be activated. For example, the one or more trigger conditions may include a gas pressure inside the gas pipeline reaching a pressure threshold, a gas concentration in an external environment of the gas pipeline reaching a concentration threshold, etc. The pressure threshold and the concentration threshold may be preset manually or default system values.

In some embodiments, the second configuration parameter includes the same content as the first configuration parameter, but the acquisition manners are different. The protection equipment corresponding to different trigger conditions and the second configuration parameters of the protection equipment corresponding to the different trigger conditions may be the same or different.

In some embodiments, the government safety supervision management platform may determine whether one or more initial trigger conditions need to be updated based on the current data, and determine one or more updated trigger conditions and a second configuration parameter (i.e., the local trigger parameter) of the protection equipment corresponding to each of the one or more updated trigger conditions, and send the one or more updated trigger conditions and the second configuration parameter of the protection equipment corresponding to the each of the one or more updated trigger conditions to the automation controller. The automation controller is configured to determine a currently triggered trigger condition and control the protection equipment to operate based on a second configuration parameter of protection equipment corresponding to the currently triggered trigger condition. Related content regarding this part may be found in the description below.

In some embodiments, the government safety supervision management platform may determine whether one or more preset conditions are satisfied based on the equipment acquisition data, the region feature data, and the terminal user feature, and determine the remote control parameter based on a first configuration parameter of the protection equipment corresponding to a satisfied preset condition. The one or more preset conditions and a correspondence between each of the one or more preset conditions and the first configuration parameter may be preset manually based on experience or historical data.

For example, a preset condition is that a gas leak occurs in a certain gas pipeline and a gas leak rate of the certain gas pipeline is greater than a rate threshold. When the preset condition is satisfied, a first configuration parameter corresponding to the preset condition is to activate protection equipment within a preset range from a gas leak location, and the higher the gas leak rate, the higher the operating intensity of activated protection equipment (such as a greater closing amplitude of the shut-off valve, etc.). The preset range is larger than a control range of an automation controller corresponding to the gas leak location.

In some embodiments, the government safety supervision management platform may determine a difference between a statistical feature of equipment acquisition data of a current period and a statistical feature of equipment acquisition data of an initial period. When the difference is greater than a difference threshold, determine that the local trigger parameter needs to be updated, and determine a new local trigger parameter by querying a preset relationship table based on the statistical feature of the equipment acquisition data of the current period.

The current period ends at a current moment. The initial period ends at a moment when the local trigger parameter was last updated. The statistical feature may be mean, variance, etc.

The preset relationship table includes statistical features and corresponding local trigger parameters. For example, when a mean gas temperature is high and a variance is large, a trigger threshold (such as the pressure threshold) of the trigger condition may be lowered, and the second configuration parameter (such as the spray speed) may be increased.

In some embodiments, the government safety supervision management platform may also update the local trigger parameter according to at least one of a change of the region feature data or a change of the terminal user feature. For example, when a population density in a certain area increases or gas consumption of the user increases, the trigger threshold of the trigger condition is lowered.

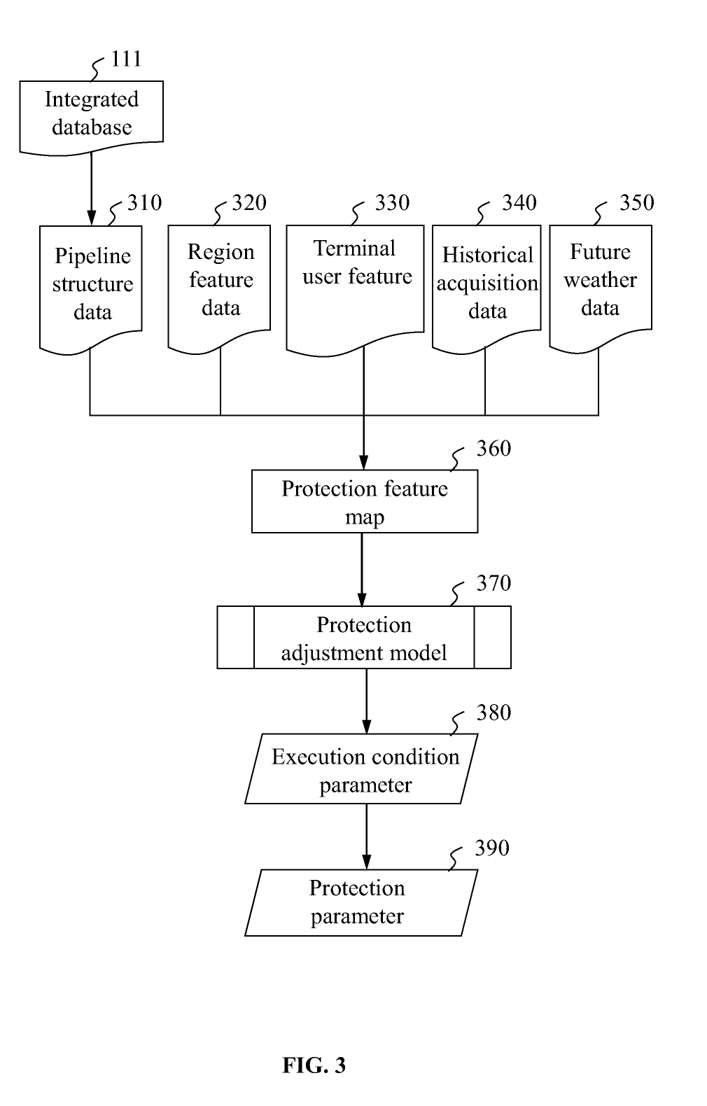

In some embodiments, the government safety supervision management platform may also construct a protection feature map based on date such as pipeline structure data, the region feature data, and the terminal user feature; determine an execution condition parameter through a protection adjustment model; and determine the protection parameter based on the execution condition parameter. More content regarding this part may be found in the related description of FIG. 3.

In some embodiments, the government safety supervision management platform may send the protection parameter to the automation controller via the gas company sensing network platform and the smart gas equipment object platform. The automation controller is configured to control the protection equipment to operate based on the protection parameter.

In some embodiments, the automation controller controlling the protection equipment to operate based on the remote control parameter includes: controlling operation of the water mist spraying device, the pressure regulating valve, and the shut-off valve based on the first configuration parameter. Specifically, it includes: controlling the water mist spraying device to spray water based on the spray speed, the spray volume, and the spray range; controlling the pressure regulating valve to adjust the gas pressure based on the rotation angle; controlling the shut-off valve to adjust a gas flow based on the closing amplitude.

In some embodiments, the automation controller controlling the protection equipment to operate based on the local trigger parameter includes: determining whether the one or more trigger conditions are triggered; and in response to determining that the one or more trigger conditions are triggered, controlling the protection equipment corresponding to the triggered trigger condition to operate based on the second configuration parameter of the protection equipment corresponding to the triggered trigger condition.

In some embodiments, the government safety supervision management platform may determine a startup result of the protection equipment in response to determining that the automation controller controls the protection equipment to start up; generate a recovery instruction and send the recovery instruction to an automatic recovery device of the protection equipment in response to determining that the startup result is a successful startup; wherein the automatic recovery device is configured to control at least one of: a rainwater collector to restore water storage, the pressure regulating valve to restore an original pressure, or the shut-off valve to be fully opened, when a recovery condition is satisfied; and generate a maintenance instruction and send the maintenance instruction to the gas company service platform in response to determining that the startup result is a failed startup.

In some embodiments, in response to determining that receiving feedback information sent by the protection equipment, the government safety supervision management platform may determine that the startup result is the successful startup. In response to determining that the feedback information sent by the protection equipment is not received, the government safety supervision management platform may determine that the startup result is the failed startup.

The recovery instruction refers to an instruction used to control the protection equipment to return to an initial state. The automatic recovery device starts automatically after receiving the recovery instruction, or inspection personnel manually control the protection equipment to return to the initial state after receiving the recovery instruction.

The initial state refers to a state of the protection equipment when the gas pipeline operates normally. For example, the water mist spraying device is in a closed state, the rainwater collector has sufficient water storage, the pressure regulating valve is fully open, the shut-off valve is fully open, etc.

The automatic recovery device refers to a structure used to control the protection equipment to return to the initial state. The automatic recovery device may be connected to the protection equipment or located inside the protection equipment. For example, the automatic recovery device may be a switch circuit, a linkage mechanism, a hydraulic cylinder, etc.

The recovery condition refers to a condition used to generate the recovery instruction. For example, the recovery condition may be an opening time of the protection equipment reaching a time threshold, etc.

In some embodiments, in response to determining that the startup result of the protection equipment is a failed startup, the government safety supervision management platform may automatically generate the maintenance instruction and send the maintenance instruction to the gas company service platform, and the gas company service platform arranges for staff to maintain the protection equipment and/or take protective measures.

In some embodiments of the present disclosure, after the protection equipment has been activated for a period of time, the gas pipeline may return to normal. For protection equipment with the successful startup, the recovery instruction is configured to control it to return to the initial state, avoiding unnecessary energy consumption, resource waste, or impact on normal gas transportation caused by prolonged activation of the protection equipment. For protection equipment with the failed startup, the maintenance instruction is configured to prompt the staff to promptly maintain the protection equipment, preventing the protection equipment from failing to respond in time when the gas pipeline is abnormal.

In some embodiments of the present disclosure, through the government safety supervision management platform globally monitoring the gas pipelines, when an abnormality occurs in the gas pipeline, a quick response is achieved based on the equipment acquisition data, and the corresponding protection equipment is remotely controlled for protection. The corresponding automation controller is also controlled to further analyze the abnormal situation, thereby controlling the protection equipment more precisely for protection according to the abnormal situation, improving the utilization efficiency and control accuracy of the protection equipment.

FIG. 3 is an exemplary schematic diagram of determining a protection parameter according to some embodiments of the present disclosure.

In some embodiments, as shown in FIG. 3, the government safety supervision management platform may obtain pipeline structure data 310 based on the integrated database 111; construct a protection feature map 360 based on the pipeline structure data 310, region feature data 320, a terminal user feature 330, historical acquisition data 340, and future weather data 350; determine an execution condition parameter 380 through a protection adjustment model 370 based on the protection feature map 360; wherein the protection adjustment model 370 is a machine learning model; and determine a protection parameter 390 based on the execution condition parameter 380.

The pipeline structure data 310 may include material data, a service life, etc., of the gas pipeline.

The historical acquisition data 340 refers to historical equipment acquisition data, including historical gas monitoring data and historical environment sensing data.

The pipeline structure data 310 and the historical acquisition data 340 may be obtained from the integrated database 111, and the future weather data 350 may be obtained from a third-party platform (e.g., a weather forecast website).

The protection feature map 360 refers to a graph structure used to reflect a distribution of the gas pipeline, the protection equipment, and the data acquisition device, including a plurality of nodes and one or more edges.

The plurality of nodes includes a first node representing a pipeline interface, a second node representing the data acquisition device, and a third node representing the protection equipment.

A node feature of the first node includes a type of pipeline interface (e.g., flange connection, welding, etc.), and region feature data of an area where the pipeline interface is located.

A node feature of the second node includes historical equipment acquisition data corresponding to the data acquisition device.

A node feature of the third node includes a type of the protection equipment, such as a lightning protection device, a high-temperature protection device, etc.

The edge of the protection feature map is a directed edge representing the gas pipeline between two nodes, and a direction of the edge indicates a direction of gas flow.

Features of the edge include the pipeline structure data, region feature data of a location of the gas pipeline, a terminal user feature corresponding to an end of the gas pipeline, future weather data of the location of the gas pipeline, etc.

The protection adjustment model 370 refers to a model used to determine the execution condition parameter. In some embodiments, the protection adjustment model 370 is the machine learning model, such as a Graph Neural Networks (GNN) model, etc.

In some embodiments, an input of the protection adjustment model 370 includes the protection feature map 360, and an output of the protection adjustment model 370 includes the execution condition parameter 380.

The execution condition parameter includes one or more conditions (e.g., the one or more preset conditions and the one or more trigger conditions) and a configuration parameter of protection equipment corresponding to each of the one or more conditions (e.g., the first configuration parameter corresponding to the preset condition and the second configuration parameter corresponding to the trigger condition). More content regarding the one or more trigger conditions, the one or more preset conditions, the first configuration parameter, and the second configuration parameter may be found in the related description of FIG. 2.

In some embodiments, the government safety supervision management platform may train the protection adjustment model based on a sample data set.

The sample data set includes a plurality of training samples and a plurality of labels corresponding to the plurality of training samples.

In some embodiments, each of the plurality of training samples includes a sample feature map. Each of the plurality of labels is a protection parameter of the protection equipment corresponding to an actual successful protection of a corresponding training sample.

In some embodiments, the plurality of labels may be obtained based on historical data or experimental data.

For example, when a gas pipeline corresponding to a certain sample feature map experiences experimental leakage a plurality of times, the government safety supervision management platform may determine a mean value of the gas concentrations in the environmental gas from a plurality of experiments, and determine the mean value as a concentration threshold in the trigger condition. Different protection schemes are used for protection experiments, and a protection scheme with the best protection effect and the least count of activated devices of the protection equipment is selected, and a configuration parameter corresponding to the protection scheme is determined as the configuration parameter in a label for the sample feature map. Different protection schemes include different activated protection equipment and different configuration parameters. The best protection effect may be the shortest completion time of protection.

In some embodiments, the government safety supervision management platform may input a training sample into an initial protection adjustment model, construct a loss function based on a protection parameter output by the initial protection adjustment model and a label corresponding to the training sample, update the initial protection adjustment model based on the loss function, and perform a plurality of rounds of iterative updates on the initial protection adjustment model. When a preset termination condition is met, the training is completed to obtain a trained protection adjustment model. The preset termination condition may be the convergence of the loss function, a count of iterations reaching a threshold, etc.

In some embodiments, the government safety supervision management platform may extract, from the execution condition parameter, at least one trigger condition corresponding to the protection equipment and a second configuration parameter corresponding to each of the at least one trigger condition, as a local trigger parameter.

In some embodiments, the government safety supervision management platform may determine, from the execution condition parameter, at least one first configuration parameter of the protection equipment, as a remote control parameter.

In some embodiments of the present disclosure, by constructing a protection feature map, facilitate the integration of various data into a single graph structure, which can reflect the relationships between data and improve data usage efficiency. Using the protection adjustment model can accurately and quickly determine the execution condition parameter, thereby improving the accuracy and efficiency of subsequently determining at least one of the remote control parameter or the local trigger parameter.

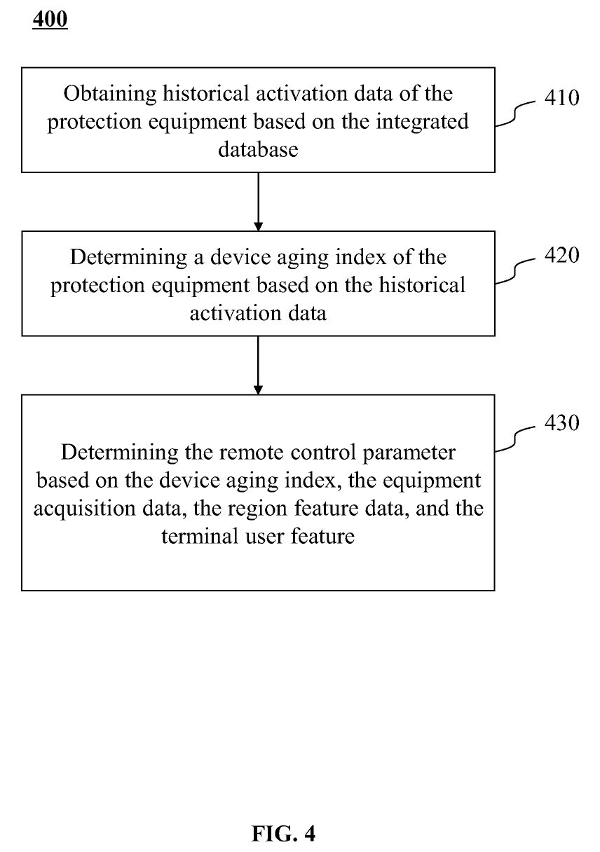

FIG. 4 is a flowchart illustrating an exemplary process of determining a remote control parameter according to some embodiments of the present disclosure. As shown in FIG. 4, a process 400 includes the following steps 410-430. In some embodiments, the process 400 may be executed by the government safety supervision management platform 110.

In some embodiments, the protection equipment further includes a pipeline lightning protection device and an anti-leakage device.

The pipeline lightning protection device may be a lightning rod, a grounding electrode, etc. The anti-leakage device may be a shut-off valve, a sealing ring, etc.

In 410, historical activation data of the protection equipment is obtained based on the integrated database.

The historical activation data may include a historical activation count, a replacement activation count, etc., of the protection equipment.

The historical activation count refers to a total count of historical activations of the protection equipment. The replacement activation count refers to a maximum historical activation count required to replace the protection equipment.

In some embodiments, the government safety supervision management platform may retrieve the historical activation data from the integrated database.

In 420, a device aging index of the protection equipment is determined based on the historical activation data.

The device aging index refers to an indicator measuring an aging condition of the protection equipment.

In some embodiments, the device aging index may be positively related to the historical activation count of the protection equipment and negatively related to the replacement activation count of the protection equipment.

In some embodiments, the device aging index is also related to a region corrosion intensity. For example, the device aging index may be positively related to the region corrosion intensity. The region corrosion intensity refers to a corrosion degree of pipelines in the area where the gas pipeline is located, which may be determined in advance manually and uploaded to the integrated database.

In some embodiments of the present disclosure, considering the impact of a corrosive environment on the protection equipment makes the determination of the device aging index more accurate.

In 430, the remote control parameter is determined based on the device aging index, the equipment acquisition data, the region feature data, and the terminal user feature.

The first configuration parameter in the remote control parameter further includes an elevation amplitude of the pipeline lightning protection device and an activation indication of the anti-leakage device.

The elevation amplitude may be represented by a rise height of the pipeline lightning protection device relative to its initial position when no protective action is performed.

The pipeline lightning protection device may include a lifting device for raising and lowering the pipeline lightning protection device.

The activation indication refers to an instruction to control the activation and deactivation of an anti-leakage device. In some embodiments, the anti-leakage device may include a release device, which may include a compression spring and a latch to prevent premature release of the spring. The release device is configured to eject a rubber block to achieve the opening and closing of the anti-leakage device.

In some embodiments, the government safety supervision management platform may determine the remote control parameter in various ways based on the device aging index, the equipment acquisition data, the region feature data, and the terminal user feature.

In some embodiments, the government safety supervision management platform may determine whether the one or more preset conditions are satisfied based on the equipment acquisition data, the region feature data, and the terminal user feature. In response to determining that a preset condition is satisfied, among the protection equipment corresponding to the satisfied preset condition, the government safety supervision management platform may choose not to activate all aging protection equipment (e.g., protection equipment whose device aging index exceeds an aging threshold) or aging protection equipment whose activation necessity is lower than a necessity threshold, and continue to monitor new equipment acquisition data after activating necessary protection equipment (e.g., protection equipment whose device aging index does not exceed the aging threshold); then determine again, based on the new equipment acquisition data, whether the one or more preset conditions are satisfied. If no preset condition is satisfied, there is still no need to activate the aging protection equipment; if preset conditions are still satisfied, then it is necessary to activate the aging protection equipment. The government safety supervision management platform may determine the remote control parameter based on a first configuration parameter of protection equipment finally determined to be activated.

The activation necessity refers to an urgency with which the protection equipment needs to be activated, which may be represented by a level or a numerical value. In some embodiments, the necessity threshold is negatively correlated with an importance degree of the gas pipeline, and the aging threshold is positively correlated with the importance degree of the gas pipeline. The greater the gas flow transported by the gas pipeline and the greater the population density of the area where the gas pipeline is located, the more important the gas pipeline.

In some embodiments, the government safety supervision management platform may determine a protection success rate using a protection success rate determination model, and determine the activation necessity based on the protection success rate.

The protection success rate refers to a success rate of the protection equipment in protecting pipeline safety.

In some implementations, the protection success rate determination model may be a machine learning model, such as a Recurrent Neural Network (RNN) model, etc.

An input of the protection success rate determination model may include a candidate device configuration scheme, the pipeline structure data, the equipment acquisition data, and the future weather data, and an output of the protection success rate determination model is a protection success rate corresponding to the candidate device configuration scheme.

For example, the government safety supervision management platform may first input the pipeline structure data, the equipment acquisition data, and the future weather data into the protection success rate determination model, then input a plurality of candidate device configuration schemes sequentially, and the protection success rate determination model outputs the protection success rate corresponding to each of the plurality of candidate device configuration schemes sequentially.

The candidate device configuration scheme refers to a scheme composed of candidate protection equipment that needs to be activated. In some embodiments, each candidate device configuration scheme may include all necessary protection equipment and randomly different aging protection equipment.

In some embodiments, a second training sample for training the protection success rate determination model includes a sample candidate device configuration scheme, sample pipeline structure data, sample equipment acquisition data, and sample future weather data. The second training sample may be obtained based on historical data or experimental data. A second label of the second training sample is a historical actual protection result or an experimental protection result corresponding to the second training sample. The second label may be manually annotated. For example, when protection is successful, the second label is 1; when protection is not successful, the second label is 0.

A training process of the protection success rate determination model may refer to the training process of the protection adjustment model and will not be repeated here.

In some embodiments, the government safety supervision management platform may determine the activation necessity of the aging protection equipment based on the protection success rate corresponding to each candidate device configuration scheme. For example, the government safety supervision management platform may compare a protection success rate of a candidate device configuration scheme containing a certain aging protection equipment with a protection success rate of a candidate device configuration scheme not containing the certain aging protection equipment. If a difference between the former and the latter is greater than a preset threshold, then the activation necessity of the certain aging protection equipment is high. If the difference between the former and the latter is less than or equal to the preset threshold, then the activation necessity of the certain aging protection equipment is low.

In some embodiments, the automation controller controlling the protection equipment to operate based on the remote control parameter further includes: controlling the pipeline lightning protection device to ascend or descend based on the elevation amplitude; and controlling the release device of the anti-leakage device to eject the rubber block based on the activation indication.

In some embodiments, after receiving the activation indication, the automation controller may control the release device to release the latch. After the latch is released, the compression spring extends, pushing the rubber block to pop out and seal the gas pipeline.

In some embodiments of the present disclosure, controlling the activation of the pipeline lightning protection device and the anti-leakage device based on the device aging index, the equipment acquisition data, the region feature data, etc., can achieve efficient management and precise execution of the protection equipment, further improve the safety, stability, and the service life of the gas pipeline, while reducing manual intervention.

In some embodiments, the government safety supervision management platform may send the device aging index to the automation controller. The automation controller is further configured to: determine, based on the device aging index, the equipment acquisition data, and the trigger condition, whether to control the protection equipment corresponding to the triggered trigger condition to operate based on the second configuration parameter of the protection equipment corresponding to the triggered trigger condition.

In some embodiments, the automation controller may determine the finally determined protection equipment to be activated from the protection equipment corresponding to the triggered trigger condition in the manner described above for determining finally determined protection equipment to be activated from the protection equipment corresponding to the satisfied preset condition, and then control the protection equipment to operate based on the corresponding second configuration parameter.

In some embodiments of the present disclosure, the operation of the protection equipment is dynamically adjusted according to its protective effect, enabling the protection equipment to make optimal responses based on actual conditions and ensuring the maximization of protective effects.

One or more embodiments of the present disclosure provide a non-transitory computer-readable storage medium, wherein the storage medium stores computer instructions, and a computer, upon reading the computer instructions in the storage medium, executes the method for autonomous protection of smart gas pipelines.

Basic concepts have been described above, and it is apparent to those skilled in the art that the detailed disclosure above is merely exemplary and does not constitute a limitation on the present disclosure. Although not explicitly stated herein, those skilled in the art may make various modifications, improvements, and amendments to the present disclosure. Such modifications, improvements, and amendments are suggested in the present disclosure, so they still belong to the spirit and scope of the exemplary embodiments of the present disclosure.

The embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly described and introduced herein.

What is claimed is:

1. An Internet of Things (IoT) system for autonomous protection of smart gas pipelines, comprising: a government safety supervision management platform and a government safety supervision object platform;
the government safety supervision management platform includes an integrated database; and the government safety supervision object platform includes a gas company management platform;
the government safety supervision management platform is configured to:
obtain equipment acquisition data and a terminal user feature through the gas company management platform;
obtain region feature data based on the integrated database; and
determine a protection parameter and send the protection parameter to an automation controller based on the equipment acquisition data, the region feature data, and the terminal user feature, wherein the automation controller is configured to control protection equipment to operate based on the protection parameter, and the protection parameter includes at least one of a remote control parameter or a local trigger parameter;
the automation controller controlling the protection equipment to operate based on the remote control parameter includes: controlling operation of a water mist spraying device, a pressure regulating valve, and a shut-off valve based on a first configuration parameter; and
the automation controller controlling the protection equipment to operate based on the local trigger parameter includes:
determining whether one or more trigger conditions are triggered; and
in response to determining that the one or more trigger conditions are triggered, controlling protection equipment corresponding to a triggered trigger condition to operate based on a second configuration parameter of the protection equipment corresponding to the triggered trigger condition.

2. The IoT system according to claim 1, wherein the IoT system further comprises a gas company service platform, and the government safety supervision management platform is further configured to:
determine a startup result of the protection equipment in response to determining that the automation controller controls the protection equipment to start up;
generate a recovery instruction and send the recovery instruction to an automatic recovery device of the protection equipment in response to determining that the startup result is a successful startup; wherein the automatic recovery device is configured to control at least one of: a rainwater collector to restore water storage, the pressure regulating valve to restore an original pressure, or the shut-off valve to be fully opened, when a recovery condition is satisfied; and
generate a maintenance instruction and send the maintenance instruction to the gas company service platform in response to determining that the startup result is a failed startup.

3. The IoT system according to claim 1, wherein the government safety supervision management platform is further configured to:
obtain pipeline structure data based on the integrated database;
construct a protection feature map based on the pipeline structure data, the region feature data, the terminal user feature, historical acquisition data, and future weather data;
determine an execution condition parameter through a protection adjustment model based on the protection feature map; wherein the protection adjustment model is a machine learning model; and
determine the protection parameter based on the execution condition parameter.

4. The IoT system according to claim 3, wherein the government safety supervision management platform is further configured to train the protection adjustment model based on a sample data set;
wherein the sample data set includes a plurality of training samples and a plurality of labels corresponding to the plurality of training samples; each of the plurality of training samples includes a sample feature map; and each of the plurality of labels is a protection parameter of the protection equipment corresponding to an actual successful protection of a corresponding training sample.

5. The IoT system according to claim 1, wherein the protection equipment further includes a pipeline lightning protection device and an anti-leakage device;
the government safety supervision management platform is further configured to:
obtain historical activation data of the protection equipment based on the integrated database;
determine a device aging index of the protection equipment based on the historical activation data; and
determine the remote control parameter based on the device aging index, the equipment acquisition data, the region feature data, and the terminal user feature; wherein the first configuration parameter in the remote control parameter further includes an elevation amplitude of the pipeline lightning protection device and an activation indication of the anti-leakage device;
the automation controller controlling the protection equipment to operate based on the remote control parameter further includes:
controlling the pipeline lightning protection device to ascend or descend based on the elevation amplitude; and
controlling a release device of the anti-leakage device to eject a rubber block based on the activation indication.

6. The IoT system according to claim 5, wherein the government safety supervision management platform is further configured to:
send the device aging index to the automation controller; wherein the automation controller is further configured to: determine, based on the device aging index, the equipment acquisition data, and the one or more trigger conditions, whether to control the protection equipment corresponding to the triggered trigger condition to operate based on the second configuration parameter of the protection equipment corresponding to the triggered trigger condition.

7. The IoT system according to claim 5, wherein the device aging index is related to a region corrosion intensity.

8. A method for autonomous protection of smart gas pipelines, wherein the method is implemented based on an Internet of Things (IoT) system for autonomous protection of smart gas pipelines, and the IoT system includes a government safety supervision management platform and a government safety supervision object platform;
the government safety supervision management platform includes an integrated database; and the government safety supervision object platform includes a gas company management platform;
the method is executed by the government safety supervision management platform and comprises:
obtaining equipment acquisition data and a terminal user feature through the gas company management platform;
obtaining region feature data based on the integrated database; and
determining a protection parameter and send the protection parameter to an automation controller based on the equipment acquisition data, the region feature data, and the terminal user feature, wherein the automation controller is configured to control protection equipment to operate based on the protection parameter, and the protection parameter includes at least one of a remote control parameter or a local trigger parameter;
the automation controller controlling the protection equipment to operate based on the remote control parameter includes: controlling operation of a water mist spraying device, a pressure regulating valve, and a shut-off valve based on a first configuration parameter; and
the automation controller controlling the protection equipment to operate based on the local trigger parameter includes:
determining whether one or more trigger conditions are triggered; and
in response to determining that the one or more trigger conditions are triggered, controlling protection equipment corresponding to a triggered trigger condition to operate based on a second configuration parameter of the protection equipment corresponding to the triggered trigger condition.

9. The method according to claim 8, further comprising:
determining a startup result of the protection equipment in response to determining that the automation controller controls the protection equipment to start up;
generating a recovery instruction and sending the recovery instruction to an automatic recovery device of the protection equipment in response to determining that the startup result is a successful startup; wherein the automatic recovery device is configured to control at least one of: a rainwater collector to restore water storage, the pressure regulating valve to restore an original pressure, or the shut-off valve to be fully opened, when a recovery condition is satisfied; and
generating a maintenance instruction and sending the maintenance instruction to the gas company service platform in response to determining that the startup result is a failed startup.

10. The method according to claim 8, wherein the determining a protection parameter based on the equipment acquisition data, the region feature data, and the terminal user feature includes:
obtaining pipeline structure data based on the integrated database;
constructing a protection feature map based on the pipeline structure data, the region feature data, the terminal user feature, historical acquisition data, and future weather data;
determining an execution condition parameter through a protection adjustment model based on the protection feature map; wherein the protection adjustment model is a machine learning model; and
determining the protection parameter based on the execution condition parameter.

11. The method according to claim 10, further comprising: training the protection adjustment model based on a sample data set;
wherein the sample data set includes a plurality of training samples and a plurality of labels corresponding to the plurality of training samples; each of the plurality of training samples includes a sample feature map; and each of the plurality of labels is a protection parameter of the protection equipment corresponding to an actual successful protection of a corresponding training sample.

12. The method according to claim 8, wherein the protection equipment further includes a pipeline lightning protection device and an anti-leakage device; and wherein the method further comprises:
obtaining historical activation data of the protection equipment based on the integrated database;
determining a device aging index of the protection equipment based on the historical activation data; and
determining the remote control parameter based on the device aging index, the equipment acquisition data, the region feature data, and the terminal user feature; wherein the first configuration parameter in the remote control parameter further includes an elevation amplitude of the pipeline lightning protection device and an activation indication of the anti-leakage device;
the automation controller controlling the protection equipment to operate based on the remote control parameter further includes:
controlling the pipeline lightning protection device to ascend or descend based on the elevation amplitude; and
controlling a release device of the anti-leakage device to eject a rubber block based on the activation indication.

13. The method according to claim 12, further comprising:
sending the device aging index to the automation controller; wherein the automation controller is further configured to: determine, based on the device aging index, the equipment acquisition data, and the one or more trigger conditions, whether to control the protection equipment corresponding to the triggered trigger condition to operate based on the second configuration parameter of the protection equipment corresponding to the triggered trigger condition.

14. The method according to claim 12, wherein the device aging index is related to a region corrosion intensity.

15. A non-transitory computer-readable storage medium, wherein the storage medium stores computer instructions, and a computer, upon reading the computer instructions in the storage medium, executes the method according to claim 8.
